(19) United States
(12) Patent Application Publication
(10) Pub. No.: US 2025/0341891 A1
(43) Pub. Date: Nov. 6, 2025

(54) REALTIME BACKGROUND EYE-TRACKING CALIBRATION

(71) Applicant: GOOGLE LLC, Mountain View, CA (US)

(72) Inventors: Baosheng James Hou, Seattle, WA (US); Mar Gonzalez Franco, Seattle, WA (US); Ivana Tosic Rodgers, Redwood City, CA (US); Prasanthi Gurumurthy, San Jose, CA (US); Eric Gonzalez, Seattle, WA (US); Khushman Patel, Sunnyvale, CA (US); Andrea Colaco, Mountain View, CA (US); Karan Ahuja, Seattle, WA (US); Lucy Abramyan, Los Gatos, CA (US)

(21) Appl. No.: 19/197,641

(22) Filed: May 2, 2025

Related U.S. Application Data
(60) Provisional application No. 63/642,426, filed on May 3, 2024.

(51) Int. Cl. G06F 3/01

(52) U.S. Cl. CPC G06F 3/013

(57) ABSTRACT

Techniques are provided for real-time calibration of an eye-tracking system in a wearable display device using user interactions with a graphical user interface. A background calibration process continuously or intermittently updates a calibration matrix based on stable gaze-target pairs inferred from natural user behavior, without requiring explicit calibration routines. The system detects user interactions such as selections of UI elements, and associates them with gaze direction data captured immediately beforehand. Fixation filtering is applied to identify stable gaze intervals based on dispersion thresholds and minimum duration criteria.

### BACKGROUND

Eye-tracking technologies are integral to modern near-eye display devices such as wearable heads-up displays (WHUDs) and other augmented reality (AR) systems, enhancing user interaction by precisely tracking gaze direction. However, calibration drift over time can degrade the accuracy of eye-tracking (ET), adversely affecting user experience. Traditional calibration methods often disrupt user activity and can be cumbersome.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates various optical field-of-view ranges for human binocular vision, for an example WHUD device, and for human symbol recognition.

FIG. 2 illustrates a schematic representation of an eye-tracking calibration process within a WHUD device, in accordance with some embodiments.

FIG. 3 illustrates a schematic representation of a calibration update process using a recursive least squares algorithm to refine the calibration matrix in a WHUD device, in accordance with some embodiments.

FIG. 4 illustrates a schematic representation of a background eye-tracking calibration system, such as may be incorporated as part of a WHUD device in accordance with some embodiments.

FIG. 5 illustrates an example of a binary tree search process used to determine optimal calibration target positions across a visual field, in accordance with some embodiments.

FIG. 6 illustrates background calibration results using a recursive least squares (RLS) update method in accordance with some embodiments.

FIG. 7 illustrates a block diagram of a computing system suitable for implementing background eye-tracking calibration functionality in accordance with some embodiments.

FIG. 8 illustrates an example wearable display device in accordance with various embodiments.

FIG. 9 illustrates an operational routine for performing real-time eye-tracking calibration based on user interface interactions, in accordance with some embodiments.

### DETAILED DESCRIPTION

Embodiments of techniques described herein provide dynamic, real-time calibration of eye-tracking systems using standard user interface (UI) interactions. The embodiments are designed to enhance user interaction within near-eye display devices such as wearable heads-up display devices by maintaining high accuracy in eye-tracking without interrupting the user's ongoing activities.

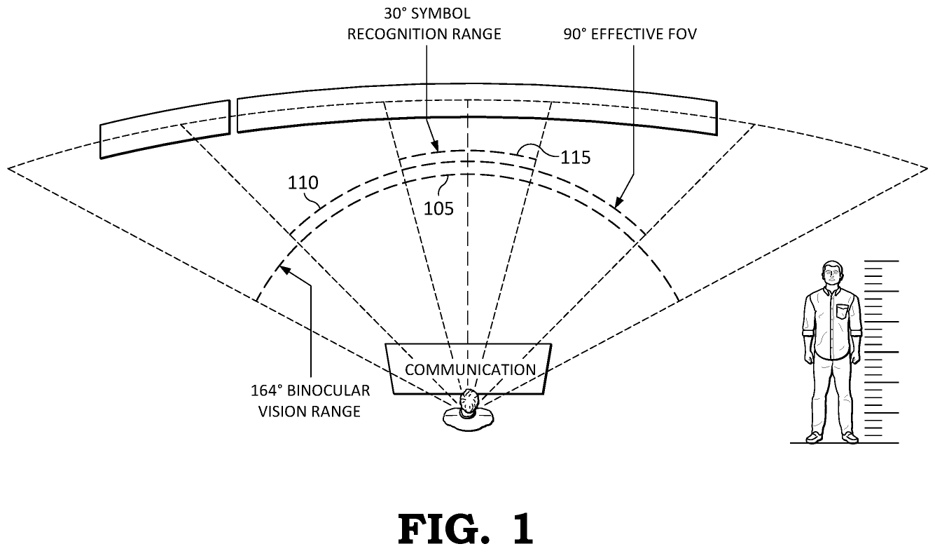

FIG. 1 illustrates various optical field-of-view (FOV) ranges, including a human binocular vision FOV range 105, an example WHUD device FOV range 110, and a human symbol recognition FOV range 115. The binocular vision FOV range 105 represents the total angular span across which both eyes contribute visual input, typically enabling depth perception and spatial awareness over a wide area. In contrast, the symbol recognition FOV range 115 indicates a more limited central region within which fine detail can be reliably perceived and interpreted—such as reading text or identifying small graphical elements.

Traditional calibration methods for eye-tracking (ET) systems often require users to participate in explicit, task-specific calibration routines that may interrupt the natural flow of interaction and diminish the overall user experience. Such routines can be fatiguing and impractical for scenarios requiring frequent or seamless use. To mitigate these limitations, certain embodiments described herein employ a background calibration process that opportunistically leverages standard UI interactions—such as selection of buttons, sliders, or other UI elements—as calibration events. This enables the ET system to dynamically adjust for positional drift and other sources of calibration error, including those that may result from repositioning, slippage, or re-donning of the WHUD device. By updating the calibration model in real time without requiring user attention or explicit engagement, the system maintains accurate gaze estimation while preserving user immersion.

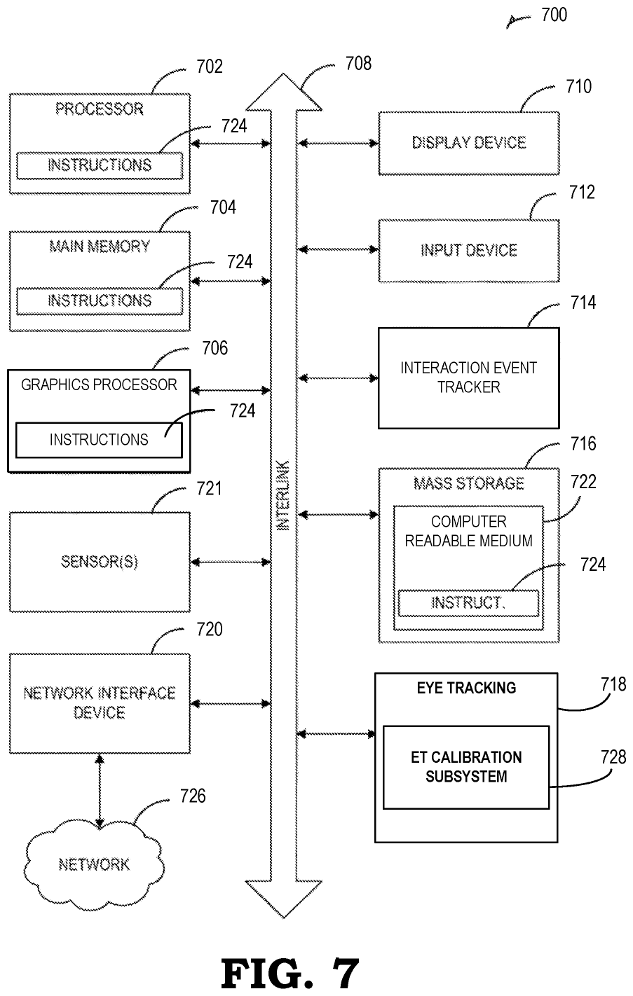

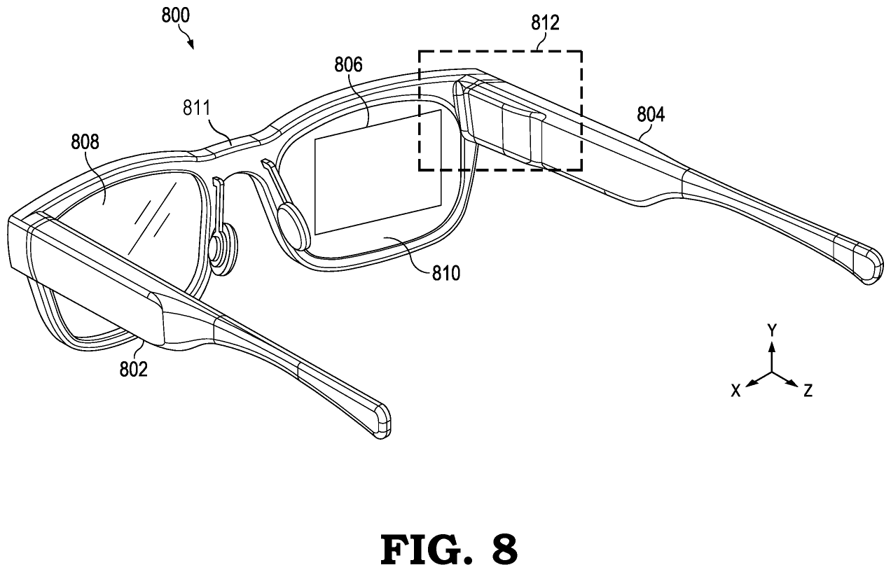

In certain embodiments, a WHUD device performs a background calibration process that updates calibration parameters based on interaction data collected during normal user activities, without initiating any foreground calibration process (i.e., a process that explicitly occupies the user's attention). This background calibration process is performed transparently, leveraging routine user interaction with the system—such as selecting buttons, adjusting sliders, dragging interface objects, or typing with a virtual keyboard—without disrupting the user experience or requiring any deliberate calibration activity. In various embodiments, the background calibration process may be performed continuously, periodically, or on a scheduled basis. As used herein and unless otherwise indicated, “the system” refers to any device, apparatus, or computing environment configured to implement one or more of the techniques described herein. In some embodiments, the system comprises a wearable display device such as a WHUD configured with one or more eye-tracking sensors, processing components, and display optics, such as exemplified in and discussed with respect to FIGS. 7 and 8 below. The system may further include software and hardware components for various operations described herein, including but not limited to processing gaze data, identifying user interactions, maintaining and updating a calibration matrix, and generating calibrated gaze estimates for interaction within a rendered user interface.

In certain embodiments, a recursive least squares (RLS) algorithm is used to adjust a calibration matrix in real time as the user interacts with UI elements within the virtual environment. As used herein, a calibration matrix refers to a set of coefficients that transform raw gaze data—typically angular measurements captured by one or more eye-tracking sensors—into calibrated positions corresponding to display coordinates. The calibration matrix is refined (such as continuously, periodically, based on one or more criteria, or as scheduled) to compensate for individual anatomical differences, sensor misalignments, or time-varying effects such as slippage, headset adjustment, or facial dynamics. In this manner, accurate gaze estimation is preserved across changing conditions.

In some embodiments, the background calibration process can also infer stable gaze-target pairs (associations between a user's estimated gaze direction and a corresponding UI element selected by the user) from patterns of near-misses followed by successful interactions. For example, if the user attempts to select a virtual object multiple times in close succession—e.g., by issuing failed pinch gestures or misfires using a mouse, controller, or other pointing device—the system may infer that the user was consistently fixating on a particular location. These inferred target locations may then be incorporated into the calibration process to further improve accuracy, even in the absence of explicit interaction signals.

In certain embodiments, an adaptive calibration strategy is employed to determine when and how to incorporate new gaze-target pairs into the calibration matrix. For example, successive updates may be responsive to an evaluation of a cumulative improvement in accuracy over time. If the improvement reaches a plateau—such as achieving 80% or 90% of a maximum observed gain—the system may suspend further updates or reduce their frequency. This adaptive mechanism allows calibration to converge efficiently while avoiding both over-correction and unnecessary computation. In certain implementations, this adaptive approach supports increased personalization by tailoring the number and intensity of calibration updates to the user's ongoing performance, rather than enforcing a fixed or arbitrary update cadence. It also mitigates the risk of overfitting to noise or transient user behavior, such as accidental selections or rapid eye movements.

Various embodiments may additionally segment the field of view into spatial regions based on observed error patterns or usage density. For example, a Voronoi partitioning of the visual field (described in greater detail elsewhere herein) may be derived from gaze fixation data, allowing region-specific calibration that better reflects user behavior and visual geometry. In some implementations, a binary tree search strategy is used to guide the selection of calibration targets, optimizing their placement to accelerate convergence and minimize the number of samples required for effective calibration.

In some embodiments, the calibration process may incorporate both head-fixed and world-fixed targets. Head-fixed targets are presented in a coordinate space that moves with the user's head, enabling isolation of eye motion, while world-fixed targets remain spatially anchored in the environment and are useful for capturing calibration points across a broader range of head positions and gaze directions. The combination of these target types allows the system to refine the calibration matrix with respect to both fine-scale eye motion and gross positional changes of the head or device.

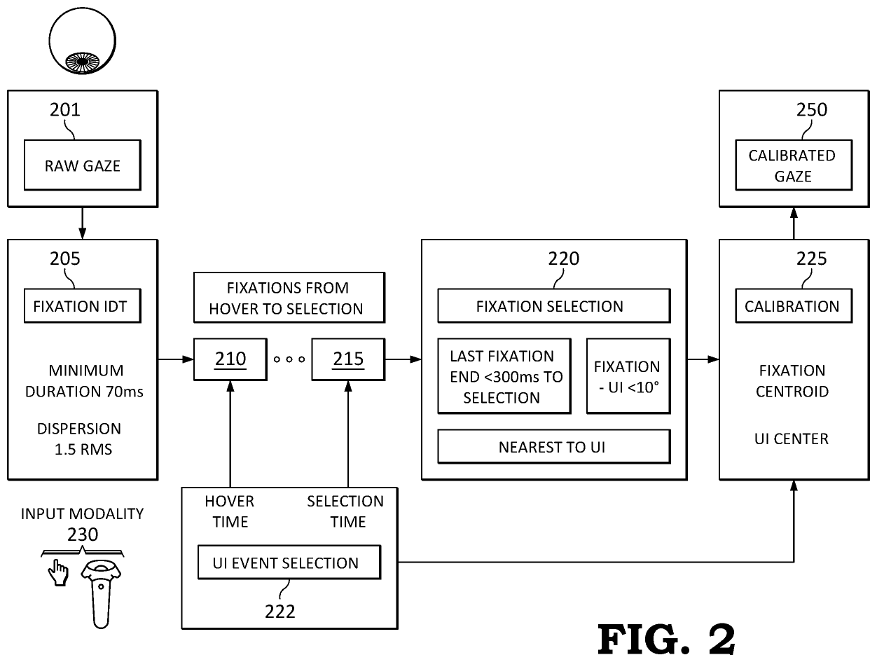

FIG. 2 illustrates a schematic representation of an eye-tracking calibration process 200 within a WHUD device, in accordance with some embodiments. In this figure, raw gaze data captures the unprocessed eye movements of the user, and UI coordinate data (which represents the user's intended focus points within the UI) are input into a calibration matrix that processes these inputs to adjust and correct the gaze data in real-time. The output from this process is a calibrated gaze, which accurately reflects the user's intended point of focus on the UI, thus enhancing eye-tracking and interaction accuracy within the virtual environment provided by the WHUD device.

In the depicted embodiment, raw gaze data 201 is continuously received from one or more eye-tracking sensors integrated into the WHUD device. This raw gaze data is processed by a fixation detection subsystem 205, which applies an identification-by-dispersion threshold (IDT) algorithm to extract stable fixation intervals from the gaze stream. In general, the fixation detection subsystem 205 identifies fixations by analyzing the spatial dispersion of gaze samples within a moving time window. When the gaze samples within the time window remain sufficiently close together—that is, within a specified spatial dispersion threshold—the algorithm classifies the interval as a fixation. If the samples are too widely dispersed, the interval is discarded as likely corresponding to a saccade or transient motion. In the illustrated example, the IDT algorithm is configured with a minimum fixation duration of approximately 70 milliseconds and a spatial dispersion threshold of 1.5 times the root-mean-square (RMS) of the gaze vector variance. These criteria help exclude transient or unstable gaze samples and isolate those likely to correspond to intentional fixation behavior.

Detected fixation windows 210, 215 (which represent any quantity of detected fixations) are passed to a fixation selection subsystem 220, which filters the fixation candidates based on their spatial and temporal proximity to a corresponding UI interaction. As indicated, in the depicted embodiment the fixation selection subsystem 220 considers only those fixation candidates that (i) end within a temporal window of less than 300 milliseconds prior to a UI selection event, (ii) are located within a 10-degree angular distance from the selected UI element, and (iii) are nearest to the selected UI element among all qualifying candidates within the relevant time window. This ensures that only high-confidence gaze-target pairs are used for calibration.

UI interaction data is received from a selection event subsystem 222, which detects user engagement with a given UI element via any of several input modalities 230, such as controller-based ray selection or direct touch. In certain embodiments, the system records a selection time and the prior hover time over the selected UI element for each selection event, enabling accurate temporal alignment between gaze behavior and user action.

Once a qualifying fixation and its corresponding UI target have been identified, a calibration subsystem 225 uses a fixation centroid and the center coordinates of the selected UI element to update the calibration matrix, such as via a recursive least squares (RLS) algorithm. The calibration matrix represents a set of coefficients mapping raw gaze angles to calibrated screen-space coordinates, and is adjusted dynamically over time based on the accumulating set of gaze-target pairs. In some embodiments, the calibration matrix update process incorporates a forgetting factor to control the influence of new data relative to historical observations, thereby maintaining stability while adapting to changes such as device slippage or head position.

The output of the calibration subsystem 225 is a calibrated gaze estimate 250, which reflects the refined, real-time mapping of the user's point of regard within the virtual environment. This calibrated gaze estimate can then be used for downstream interaction tasks, such as gaze-based selection, navigation, or attention inference.

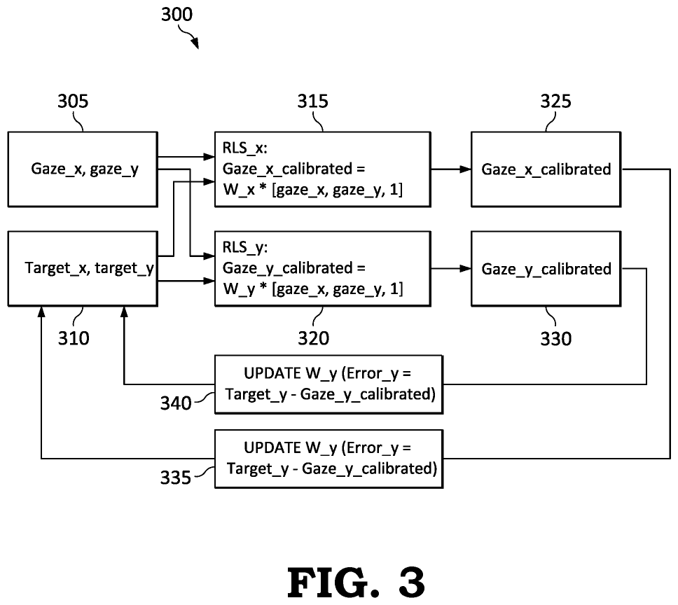

FIG. 3 illustrates a schematic representation of a calibration update process 300 using an RLS algorithm to refine the calibration matrix in a WHUD device, in accordance with some embodiments. The calibration update process 300 begins with the collection of paired data samples comprising raw gaze coordinates 305, such as obtained by capturing median gaze angles over a defined period (e.g., 300 milliseconds) prior to a UI selection and corresponding target coordinates 310. In certain embodiments, the raw gaze coordinates 305 are expressed in angular units or other device-relative values, while the target coordinates 310 correspond to known UI positions with which the user interacts—the screen-space or UI-relative position the user is focused on during a given interaction. In certain embodiments, the known UI positions are derived from the fixation and UI selection process 200 (FIG. 2).

Each new gaze-target pair is provided to a horizontal calibrator 315 (RLS_x) and a vertical calibrator 320 (RLS_y), each of which computes a forward-calibrated output by applying a calibration matrix W to the input gaze vector. In the illustrated example, the horizontal calibrator 315 applies the weight matrix Wₓ (the horizontal components of calibration matrix W) to the vector [gazeₓ, gaze_{y}, 1] to produce a calibrated horizontal gaze estimate 325. Similarly, vertical calibrator 320 applies a corresponding matrix W_{y} (the vertical components of calibration matrix W) to the vector [gazeₓ, gaze_{y}, 1] to produce a calibrated vertical gaze estimate 330. These calibrated gaze coordinates 325, 330 represent the predicted point of regard in screen-space coordinates, such as may be used for real-time user interaction within the virtual environment.

In certain implementations, the weights of the calibration matrix may be expressed as a first-degree polynomial:

$$x\_calibrated = {A}_{x} * x + {B}_{x} * y + {C}_{x}$$

$$y\_calibrated = {A}_{y} * x + {B}_{y} * y + {C}_{y}$$

Here, x and y represent the raw gaze angles, and Aₓ, Bₓ, Cₓ, A_{y}, B_{y}, and C_{y} are the calibration coefficients that are dynamically adjusted by the RLS algorithm based on ongoing user interactions.

To improve the calibration over time, the calibration update process 300 includes a comparison of the calibrated gaze estimates 325, 330 to the corresponding known target coordinates 310. This comparison is used to compute an error signal for each axis, such as (in the depicted embodiment) the difference between the target coordinate and the calibrated gaze estimate. These error values are then used to update the corresponding calibration matrix W (comprising matrices Wₓ and W_{y}), as depicted by matrix update subsystems 335 and 340. In some embodiments, these updates are computed using a recursive least squares formulation that incrementally adjusts the weights to minimize the squared prediction error over time.

In certain embodiments, the calibration update process 300 incorporates a forgetting factor to determine how much influence recent samples have relative to older observations. As one example, the forgetting factor may be incrementally reduced (e.g., by increments of 0.1) from an initial nominal value (e.g., 0.95) if the gaze-target error exceeds a threshold (e.g., 0.5 degrees), increasing responsiveness to recent input. After the error stabilizes or a maximum number of adjustment iterations is reached, the forgetting factor may be reset to its nominal value to maintain long-term stability.

It will be appreciated that while for ease of illustration FIG. 3 shows the transformation and update steps as separate computational paths, in some embodiments they are integrated, such as to process each new fixation-target pair in real time. This configuration enables an incorporating WHUD device, for example, to continuously refine its gaze calibration without requiring explicit recalibration procedures.

In certain embodiments, the system continuously performs background calibration in connection with UI interactions. In other embodiments, the system selectively determines whether to execute a background calibration update based on one or more evaluation criteria. For example, certain conditions related to fixation stability, gaze-target proximity, or cumulative accuracy improvement may be applied to determine whether a new calibration update should be performed. The following pseudocode illustrates an example of such conditional update behavior.

```
gazeWindow = FillWindow(winlen=300ms, sample=gaze_XYZ)
If UIClicked:
  target_x, target_y = Vec2VisAng(target_XYZ)
  gaze_x, gaze_y = Median( Vec2VisAng( gazeWindow ) )
  observations.append([gaze_x, gaze_y], [target_x, target_y])
  If calibration_criteria_met( ):
    RunBackgroundCalibration( )
    If need_total_recalibration( ):
      RunFullCalibration( )
```

As shown, a window of recent gaze data is first accumulated in a buffer using a function FillWindow, which gathers samples over a defined time interval (here, 300 ms). If a UI selection event is detected (via UIClicked), the system identifies the intended target location—e.g., the coordinates of the selected UI element—and converts those coordinates into angular units using a transformation function Vec2VisAng. The raw gaze data in the buffer is likewise converted to angular form and reduced to a single point estimate via Median(Vec2VisAng(gazeWindow)). These two vectors (gaze and target) form a candidate gaze-target pair, which is appended to an observation history or calibration queue via observations.append([gaze_x, gaze_y], [target_x, target_y]).

The system then evaluates whether the calibration criteria are met, such as verifying that the gaze-target error is below a certain threshold or that sufficient data has been collected (as non-limiting examples). If so, the system initiates a background calibration update via RunBackgroundCalibration( ). If the evaluation indicates that a complete recalibration is warranted, such as due to accumulated drift or re-wearing of the incorporating WHUD device, a more extensive recalibration procedure is initiated via RunFullCalibration( ). This architecture supports flexible calibration logic that adapts to user behavior and system conditions without explicit user intervention.

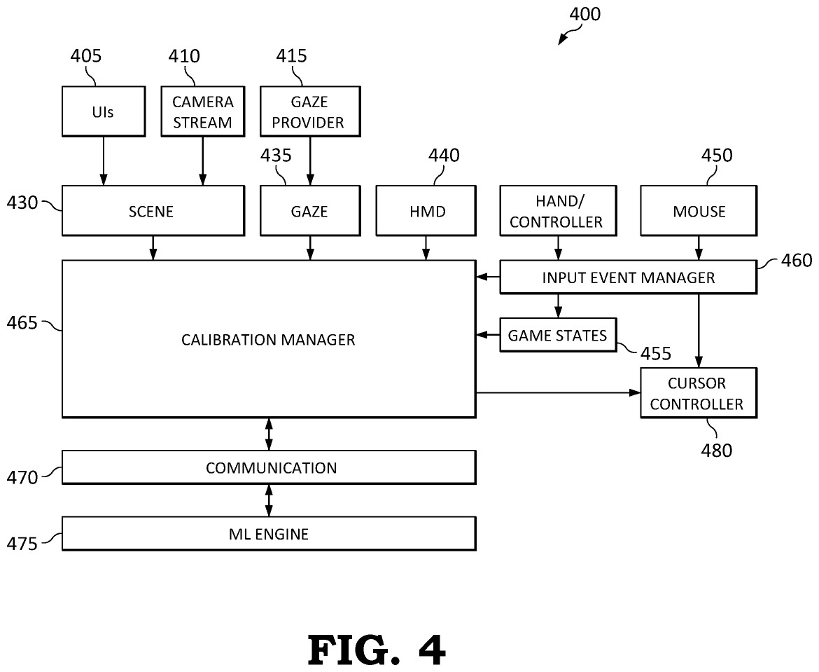

FIG. 4 illustrates a schematic representation of a background ET calibration system 400, such as may be incorporated as part of a WHUD device in accordance with some embodiments. This representation depicts the interaction of various functional components used to support real-time calibration of gaze data based on user interaction events, such as within a rendered virtual or augmented environment.

In the depicted embodiment, a set of user interface definitions 405 specifies the layout and behavior of virtual UI elements available to the user during operation. A camera stream 410 provides input imagery used by the gaze tracking subsystem, and a gaze provider 415 processes that imagery to generate raw gaze data representative of the user's point of regard. Information from the camera stream 410 and the UI definitions 405 is used to construct a current view of the rendered environment via a scene module 430. The gaze data is supplied to a gaze module 435, and device pose and orientation are managed by an HMD module 440, which tracks the physical configuration of the incorporating WHUD device.

User input may be received via hand tracking, controller-based selection mechanisms, or via a mouse or other standard pointing device. In the depicted embodiment, a hand/controller module 445 collects corresponding input events, while a mouse module 450 captures input events including cursor movement and click actions from pointer-based interfaces. These interaction events are processed by an input event manager 460, which in the present embodiment aggregates and timestamps user selections, manages the interaction context, and supports event tracking across different input modalities.

A game state module 455 maintains application-level context such as current UI mode, interaction history, and environmental conditions that may influence calibration behavior. Input event manager 460 and game state module 455 both supply contextual data to a calibration manager 465, which coordinates the background calibration process. The calibration manager 465 receives gaze data from the gaze module 435, UI and scene information from the scene module 430, device pose data from the HMD module 440, and interaction data from the input event manager 460. Using this data, the calibration manager 465 identifies candidate gaze-target pairs and determines whether to update the calibration matrix. In certain embodiments, updates may be selectively applied based on evaluation criteria such as fixation stability, gaze-target proximity, recent calibration performance, or accumulated error thresholds. In some embodiments, these updates are performed using a recursive least squares (RLS) approach, as described with respect to FIG. 3 elsewhere herein.

In some embodiments, the system determines whether to perform a calibration matrix update based in part on whether a correction event follows the initial user interaction. As used herein, a correction event refers to a user action that suggests the initial selection was inaccurate or unintended—for example, immediately issuing a deletion or undo command, selecting a different nearby UI element within a short time interval, or rapidly re-adjusting a manipulated control such as a slider. The presence of a correction event may indicate that the corresponding gaze-target pair does not reflect a valid association between gaze direction and intended target, and may therefore be excluded from calibration. This filtering step helps maintain the reliability of the calibration matrix by preventing the incorporation of interaction events that are likely to have been erroneous or imprecise.

Calibrated gaze estimates are routed from the calibration manager 465 to a cursor controller 480, which applies the corrected gaze positions to support downstream operations such as gaze-based selection, cursor positioning, or visual feedback generation. The calibration manager 465 also interacts with a communication subsystem 470, which facilitates coordination with auxiliary system components, including (in the depicted embodiment) a machine learning (ML) engine 475. In certain embodiments, the ML engine 475 is used to dynamically adjust calibration matrix parameters based on user behavior, prior calibration outcomes, or regional error characteristics within the display field.

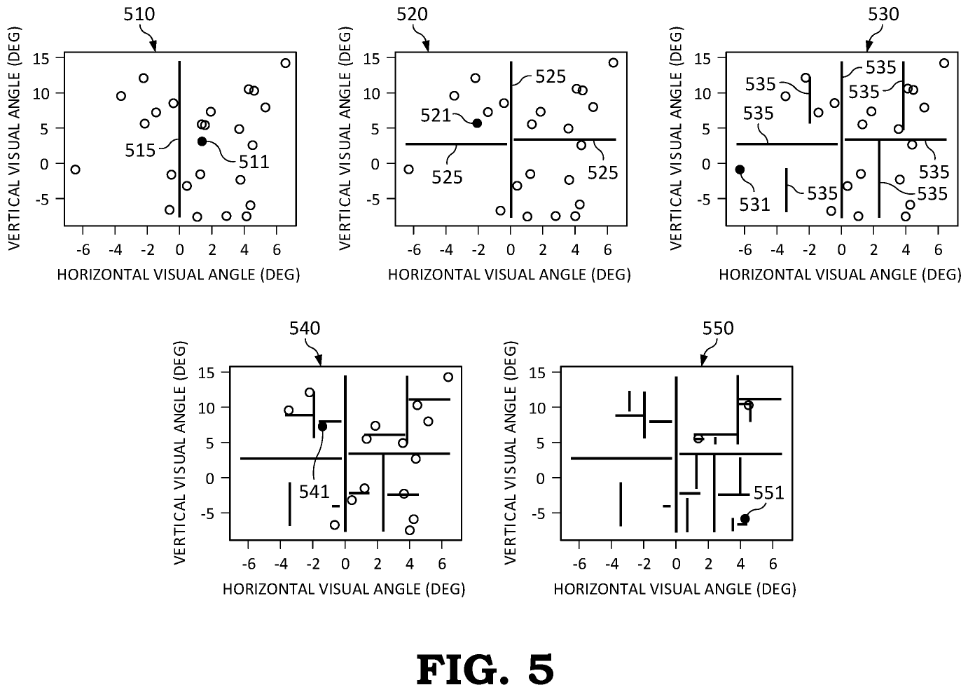

Although various embodiments employing the calibration techniques described above utilize naturally occurring user interface interactions to incrementally refine a calibration matrix, in various scenarios those UI interactions may not be uniformly distributed across the user's field of view. Over time, this can result in uneven calibration accuracy, particularly in peripheral or rarely engaged regions. To address this, certain embodiments apply one or more spatial partitioning strategies to evaluate calibration coverage across the display area and guide targeted recalibration efforts when needed. Such strategies may be used to assess regional calibration quality during background (or foreground) operation, as well as to inform whether additional calibration data is needed for a given area. As one non-limiting example, the spatial strategy discussed below with respect to FIG. 5 supports both adaptive fallback behavior and region-specific calibration refinement, such as within the background real-time calibration framework described above.

FIG. 5 illustrates an example of a binary tree search process used to determine optimal calibration target positions across the visual field, in accordance with some embodiments. As depicted, each of five separate sample plots 510, 520, 530, 540, and 550 represents a noncontiguous iteration in a spatial subdivision process used to generate candidate calibration target locations for an eye-tracking system. This process facilitates region-aware calibration by iteratively partitioning the visual field and selecting new target positions that improve spatial coverage and calibration uniformity.

Each plot 510, 520, 530, 540, and 550 corresponds to a view of the user's horizontal and vertical visual angles, measured in degrees. The dots represent a fixed pool of potential target positions, while the highlighted dot in each plot (e.g., 511, 521, 531, 541, 551) indicates the most recently selected calibration target. Vertical and horizontal partition lines (e.g., 515, 525, 535) denote the partitioning of the field using axis-aligned binary splits.

The process begins in plot 510, where a vertical partition 515 divides the display, and an initial calibration target 511 is selected near the center of one of the resulting regions. In each subsequent plot, the current grid is subdivided further-first into approximate halves, then approximate quarters, then approximate eighths and beyond-creating progressively finer regions across the visual field. These subdivisions alternate between horizontal and vertical axes to maintain balance and ensure comprehensive spatial refinement. In plot 520, partitions 525 are formed to continue dividing the visual field, and a second target 521 is selected. In plot 530, partitions 535 are formed to divide the visual field still further, and a third target 531 is selected. Plots 540 and 550 show further subdivisions and placements (541, 551), continuing the binary tree expansion. By plot 550, the entire space has been densely partitioned, and the final calibration target 551 is selected.

In contrast to conventional calibration grids that rely on regular point distributions, the binary tree search method dynamically places calibration points based on spatial opportunity and relevance. During each iteration, the system selects a region that has not yet been assigned a target to avoid clustering and to promote even distribution. This supports both spatial balance and localized accuracy improvements. Although the total number of potential targets (22 in this example) remains constant, the order and spacing of their selection are dynamically determined based on the partitioned grid structure and current calibration needs. This process allows the calibration strategy to be responsive to actual usage behavior—for instance, adapting when the user naturally shifts their gaze or head orientation. In this manner, the ET calibration system begins to deviate from an initial uniform grid and instead reflects a spatial distribution aligned with user interaction patterns.

By leveraging this binary tree selection strategy, the system is able to reduce the total number of calibration targets needed while maximizing coverage and calibration quality across the full extent of the display space. Each additional UI interaction refines the system's gaze-mapping accuracy and supports continuous adaptation of the calibration matrix during both initial setup and ongoing use.

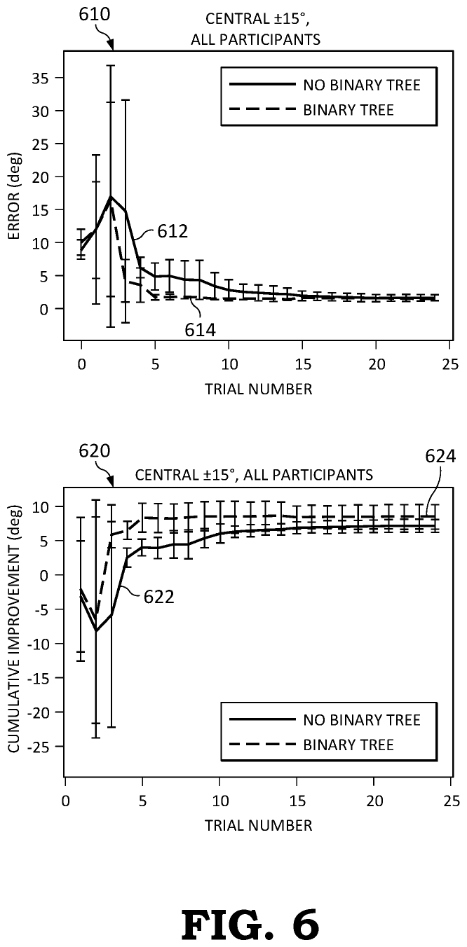

FIG. 6 illustrates background calibration results using a recursive least squares (RLS) update method in accordance with some embodiments, comparing the effectiveness of calibration target selection with and without the use of a binary tree strategy. The results depicted in this figure were aggregated across multiple participants and evaluated for a central ±15 degrees of those participants' visual field.

Plot 610 shows the calibration error in degrees over a series of background calibration trials. The horizontal axis corresponds to the trial number, and the vertical axis indicates the average angular error between predicted gaze position and known UI target location. Line 612 represents the calibration performance when no binary tree-based selection was used, while line 614 represents calibration performance using spatially structured target selection according to the binary tree method described in FIG. 5. As shown, both conditions exhibit a rapid reduction in error during early trials, with the binary tree condition 614 converging more quickly—roughly by the fifth such trial—and to a lower overall error than the unstructured approach 612, which fails to converge until roughly the 15th trial.

Plot 620 shows the corresponding cumulative improvement in calibration accuracy across trials. The vertical axis denotes cumulative improvement in degrees (relative to the starting condition), and the horizontal axis again represents trial number. Line 622 shows the performance trajectory without binary tree-based selection, while line 624 shows the cumulative improvement observed when using binary tree-guided target placement. Both conditions initially exhibit volatility during the first few trials, but the binary tree condition 624 achieves faster convergence—again, roughly at the fifth trial—and a more stable improvement plateau than the baseline condition 622. Thus, structured spatial coverage—such as that provided by the binary tree subdivision approach described above with respect to FIG. 5—demonstrably enhances the efficiency and effectiveness of background calibration.

FIG. 7 illustrates a block diagram of a computing system 700 suitable for implementing background eye-tracking calibration functionality in accordance with some embodiments. The computing system 700 may correspond to (or be incorporated within) a wearable heads-up display (WHUD) device, as with other suitable computing platforms configured to support real-time gaze tracking, user interaction processing, and calibration operations.

The system 700 includes a processor 702 communicatively coupled to a main memory 704, a graphics processor 706, and a set of peripheral and functional components via an interconnect 708. The processor 702 and graphics processor 706 may each be configured to execute instructions 724 stored in memory 704 or other local memory, including (as non-limiting examples) instructions for processing gaze data, updating a calibration matrix, and rendering or displaying AR content. The graphics processor 706 may additionally support the rendering of UI elements and management of visual feedback based on user gaze.

The system further includes a display device 710 configured to output visual content to the user, such as AR graphical overlays. Input device 712 may include one or more user interface components (e.g., touch sensors, buttons, or controllers) through which a user may interact with the system. In some embodiments, UI selection actions are derived from gestures, pointing devices, or other interaction modalities tracked by the system. These are processed by an interaction event tracker 714, which aggregates hover durations, selection timestamps, and other contextual information used in the calibration process. In certain embodiments, data collected by the interaction event tracker 714 may correspond to the UI selection events depicted and discussed with respect to FIG. 2.

Mass storage 716 includes a computer-readable medium 722 storing instructions 724 and data used by various components of the system, such as calibration history, user interaction logs, and gaze model parameters. A network interface device 720 enables communication with external systems or devices via a network 726, which may be used for remote updates, telemetry, or synchronization of user-specific calibration profiles.

A sensor module 721 includes one or more sensors used to capture gaze data, head pose, or environmental conditions. In various embodiments, sensor module 721 includes one or more eye-facing cameras, inertial measurement units (IMUs), or ambient light sensors. Gaze data obtained from such sensors is processed by an eye tracking component 718, which may perform image preprocessing, pupil center estimation, or gaze vector projection.

Within the eye tracking component 718, an ET calibration subsystem 728 is configured to process detected fixations, identify high-confidence gaze-target pairs, and update a calibration matrix in accordance with the techniques described herein. In some embodiments, the ET calibration subsystem 728 implements a recursive least squares (RLS) approach to refine calibration parameters in real time based on implicit feedback derived from UI interaction events. Calibration updates may be selectively applied based on error thresholds, interaction confidence, or spatial proximity to a UI selection, and may perform one or more such operations responsive to the interaction event tracking component 714.

Although FIG. 7 illustrates a particular computing configuration, in various embodiments and scenarios one or more of the illustrated components (e.g., the ET calibration subsystem 728 or interaction tracking module 714) may be implemented in dedicated hardware, software, firmware, or any combination thereof, and may be distributed across components of a WHUD device or offloaded to external processing resources as needed.

FIG. 8 illustrates a rear perspective view of a wearable heads-up display system 800 implementing waveguide with one or more diffractive gratings, in accordance with some embodiments. The display system 800 includes a support structure 802 (e.g., a support frame) to mount to a head of a user and that includes an arm 804 that houses a laser projection system, micro-display (e.g., micro-light emitting diode (LED) display), or other light engine configured to project display light representative of images toward the eye of a user, such that the user perceives the projected display light as a sequence of images displayed in a field of view (FOV) area 806 at one or both of lens elements 808, 810 supported by the support structure 802 and using one or more display optics. The display optics may include one or more instances of optical elements selected from a group that includes at least: a waveguide (references to which, as used herein, include and encompass both light guides and waveguides), a holographic optical element, a prism, a diffraction grating, a light reflector, a light reflector array, a light refractor, a light refractor array, or any other light-redirection technology as appropriate for a given application, positioned and oriented to redirect the AR content from the light engine 811 towards the eye of the user. In some embodiments, the support structure 802 further includes various sensors, such as one or more front-facing cameras, rear-facing cameras (e.g., for eye tracking), other light sensors, motion sensors, accelerometers, and the like. The support structure 802 further can include one or more radio frequency (RF) interfaces or other wireless interfaces, such as a Bluetooth™ interface, a WiFi interface, and the like.

The support structure 802 further can include one or more batteries or other portable power sources for supplying power to the electrical components of the display system 800. In some embodiments, some or all of these components of the display system 800 are fully or partially contained within an inner volume of support structure 802, such as within the arm 804 in region 812 of the support structure 802. In the illustrated implementation, the display system 800 utilizes an eyeglasses form factor. However, the display system 800 is not limited to this form factor and thus may have a different shape and appearance from the eyeglasses frame depicted in FIG. 8.

One or both of the lens elements 808, 810 are used by the display system 800 to provide an augmented reality (AR) display in which rendered graphical content can be superimposed over or otherwise provided in conjunction with a real-world view as perceived by the user through the lens elements 808, 810. For example, laser light or other display light is used to form a perceptible image or series of images that are projected onto the eye of the user via one or more optical elements, including a waveguide, formed at least partially in the corresponding lens element. One or both of the lens elements 808, 810 thus includes at least a portion of a waveguide that routes display light received by an incoupler (IC) (not shown in FIG. 8) of the waveguide to an outcoupler (OC) (not shown in FIG. 8) of the waveguide, which outputs the display light toward an eye of a user of the display system 800. Additionally, the waveguide employs an exit pupil expander (EPE) (not shown in FIG. 8) in the light path between the IC and OC, or in combination with the OC, in order to increase the dimensions of the display exit pupil. Each of the lens elements 808, 810 is sufficiently transparent to allow a user to see through the lens elements to provide a field of view of the user's real-world environment such that the image appears superimposed over at least a portion of the real-world environment.

In addition to providing AR display functionality, the support structure 802 includes sensing and processing components relevant to the real-time background calibration techniques described elsewhere in this specification. For example, one or more eye-facing cameras or other optical sensors (such as may correspond to sensors 721 of FIG. 7, discussed elsewhere herein) may be integrated behind or near the lens elements to capture raw gaze data. In various embodiments, such sensors may be located along the inner surface of the frame and/or behind transparent portions of the lens. Captured gaze data is processed to estimate the user's point of regard within the virtual display space, and in some embodiments, these estimates are refined through background calibration updates using natural UI interactions as described with respect to FIGS. 2 through 4.

In various embodiments, region 812 of the frame arm 804 may contain additional components such as one or more batteries, wireless communication interfaces (e.g., Bluetooth, WiFi), motion sensors, or onboard processors that execute calibration-related logic. This may include logic for, e.g., computing fixation windows, selecting valid gaze-target pairs, applying recursive least squares updates, or managing communication with a host ML engine for calibration evaluation and control. In some embodiments, calibration updates may be selectively applied based on error thresholds or device movement, such as when the WHUD system 800 is repositioned on the user's head or subjected to slippage.

Non-limiting example display architectures include scanning laser projector and holographic optical element combinations, side-illuminated optical light guide displays, pin-light displays, or any other wearable heads-up display technology as appropriate for a given application. The term light engine as used herein is not limited to referring to a singular light source, but can also refer to a plurality of light sources, and can also refer to a light engine assembly. A light engine assembly may include some components which enable the light engine to function, or which improve operation of the light engine. As one example, a light engine may include a light source, such as a laser or a plurality of lasers. The light engine assembly may additionally include electrical components, such as driver circuitry to power the at least one light source. The light engine assembly may additionally include optical components, such as collimation lenses, a beam combiner, or beam shaping optics. The light engine assembly may additionally include beam redirection optics, such as least one MEMS mirror, which can be operated to scan light from at least one laser light source, such as in a scanning laser projector. In the above example, the light engine assembly includes a light source and also components, which take the output from at least one light source and produce conditioned display light to convey AR content. All of the components in the light engine assembly may be included in a housing of the light engine assembly, affixed to a substrate of the light engine assembly, such as a printed circuit board or similar, or separately mounted components of the WHUD system 800.

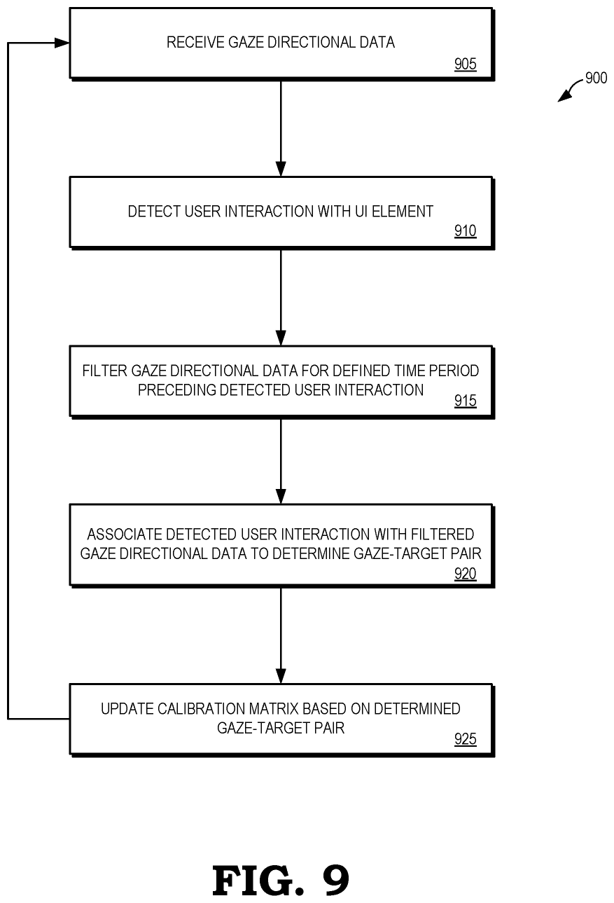

FIG. 9 illustrates an operational routine 900 for performing real-time eye-tracking calibration based on user interface interactions, in accordance with some embodiments. This routine may be performed by (for example) a calibration subsystem of a wearable heads-up display device, such as the ET calibration subsystem 728 described with reference to FIG. 7.

The operational routine begins at block 905, in which the system receives gaze directional data from one or more sensors configured to capture eye movement signals. This data may represent angular gaze vectors, projected gaze coordinates, or raw sample streams from which such values can be derived. In various embodiments and scenarios, the gaze data is received continuously or at regular sampling intervals during system operation. The routine proceeds to block 910.

At block 910, the system detects a user interaction with a user interface of the wearable display device. Such interactions may include, for example, selection of a UI element using a controller input, gesture, tap, mouse click, or other input modality. The routine proceeds to block 915.

At block 915, the system filters the gaze directional data for a defined time period preceding the detected interaction. This filtering is configured to identify stable fixations that likely correspond to the user's intended point of focus prior to executing the UI interaction. In some embodiments, fixation detection is performed using one or more of a minimum fixation duration or a spatial dispersion threshold to exclude transient or unstable gaze segments. The routine proceeds to block 920.

At block 920, the system associates the detected UI interaction with the filtered gaze directional data to determine a gaze-target pair, which represents an inferred mapping between where the user was looking and which interface element was acted upon. In some embodiments, a centroid of the fixation is identified and associated with the spatial location of the activated UI element. The routine proceeds to block 925.

At block 925, the system updates a calibration matrix based on the determined gaze-target pair. The calibration matrix may encode an affine transformation or other mapping from raw gaze coordinates to display-referenced coordinates. In some embodiments, the calibration matrix is updated using a recursive least squares (RLS) algorithm to incrementally refine gaze prediction parameters in real time, without requiring explicit calibration prompts or providing any indication of gaze calibration to the user. Following the update of the calibration matrix, the routine returns to block 905 to receive additional gaze directional data until a subsequent user interaction with a UI element is detected.

In various embodiments, the operational routine 900 may be repeated for each interaction event or as part of a continuous background calibration process, allowing the system to adapt dynamically to changes in headset position, user posture, or other factors affecting gaze accuracy. In some embodiments, updates may be gated or deferred based on error thresholds, correction event detection, or convergence criteria as described elsewhere in this specification.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” etc.) are described or claimed as “configured” to perform one or more tasks or operations. This formulation—[entity] configured to [perform one or more tasks]—is used herein to refer to physical structure, e.g., electronic circuitry. More specifically, this formulation is used to indicate that this physical structure is arranged to perform the one or more tasks during operation. Such physical structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements. In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
detecting a first user interaction with a user interface of a wearable display device by a user;
associating the first user interaction with information regarding a gaze direction of the user to determine a gaze-target pair; and
prior to detecting a second user interaction with the user interface, updating a calibration of the wearable display device based on the determined gaze-target pair, the calibration correlating gaze directional data with one or more calibrated gaze positions of the wearable display device.

2. The method of claim 1, further comprising generating the gaze directional data for a defined time period preceding the first user interaction by filtering raw gaze data from the defined time period using one or more of a minimum fixation duration or a spatial dispersion threshold.

3. The method of claim 2, wherein associating the first user interaction with the information regarding the gaze direction comprises identifying a centroid for one or more samples in the gaze directional data that occur during the defined time period.

4. The method of claim 1, wherein updating the calibration comprises adjusting coefficients of a calibration matrix based on a difference between a gaze direction of a respective gaze-target pair and a user interface target of the respective gaze-target pair.

5. The method of claim 4, wherein updating the calibration comprises dynamically adjusting a forgetting factor based on a magnitude of the difference between the gaze direction and the user interface target.

6. The method of claim 4, wherein adjusting the coefficients of the calibration matrix comprises applying a recursive least squares algorithm.

7. The method of claim 1, further comprising determining to update the calibration based at least in part on one or more criteria selected from a group that includes a distance between the gaze direction and a target of the first user interaction, a stability metric of the gaze direction, or occurrence of a correction event.

8. The method of claim 1, further comprising evaluating cumulative calibration accuracy over a plurality of updates responsive to multiple determined gaze-target pairs, and suspending one or more additional updates of the calibration based at least in part on the evaluating.

9. The method of claim 1, further comprising prioritizing one or more additional updates of the calibration corresponding to at least one determined gaze-target pair in a first region of the display device having fewer determined gaze-target pairs than one or more other regions of the display device.

10. The method of claim 9, further comprising determining the first region by applying a spatial partitioning strategy based on a binary tree subdivision of a visual field.

11. The method of claim 1, wherein the first user interaction comprises a selection of a graphical user interface element.

12. The method of claim 1, wherein the method is performed without providing an indication of gaze calibration to the user.

13. A wearable display device, comprising:
one or more sensors to provide gaze directional data;
a memory to store a calibration matrix, wherein the calibration matrix correlates the gaze directional data with one or more calibrated gaze positions of the wearable display device; and
one more processors to:
detect a first user interaction with a user interface of the wearable display device by a user;
associate the first user interaction with information regarding a gaze direction of the user to determine a gaze-target pair; and
prior to detection of a second user interaction with the user interface, update the calibration matrix based on the determined gaze-target pair.

14. The wearable display device of claim 13, wherein the one or more processors are further to filter the gaze directional data using one or more of a minimum fixation duration, a spatial dispersion threshold, or a defined time period preceding the first user interaction.

15. The wearable display device of claim 14, wherein to associate the first user interaction with the information regarding the gaze direction comprises identifying a centroid for one or more samples in the gaze directional data that occur during the defined time period.

16. The wearable display device of claim 13, wherein to update the calibration matrix comprises adjusting coefficients of the calibration matrix based on a difference between a gaze direction of the identified gaze-target pair and a target of the first user interaction for the identified gaze-target pair.

17. The wearable display device of claim 13, wherein the one or more processors are further to determine to update the calibration matrix based at least in part on one or more criteria selected from a group that includes a distance between the gaze direction and the user interface target, a stability metric of the gaze direction, or occurrence of a correction event.

18. The wearable display device of claim 13, wherein the one or more processors are further to evaluate cumulative calibration accuracy over a plurality of calibration matrix updates responsive to multiple determined gaze-target pairs, and to suspend one or more additional updates of the calibration matrix based at least in part on the evaluation.

19. A non-transitory computer-readable medium storing instructions that, when executed by one or more processors, manipulate the one or more processors to:
detect a first user interaction with a user interface of a wearable display device by a user;
associate the first user interaction with information regarding a gaze direction of the user to determine a gaze-target pair; and
prior to detecting a second user interaction with the user interface, update a calibration of the wearable display device based on the determined gaze-target pair, the calibration correlating gaze directional data with one or more calibrated gaze positions of the wearable display device.

20. The non-transitory computer-readable medium of claim 19, wherein the instructions further manipulate the one or more processors to generate the gaze directional data for a defined time period preceding the first user interaction by filtering raw gaze data from the defined time period using one or more of a minimum fixation duration or a spatial dispersion threshold.
